(19) United States
(12) Patent Application Publication
(10) Pub. No.: US 2016/0088412 A1
(43) Pub. Date: Mar. 24, 2016

(54) METHOD OF MANUFACTURING DIAPHRAGM

(71) Applicant: MERRY ELECTRONICS (SUZHOU) CO., LTD., Suzhou City (CN)

(72) Inventors: Tse-Yu LIU, Taichung City (TW); Zhi-Yuan LI, Taichung City (TW); Yuan YUAN, Taichung City (TW)

(21) Appl. No.: 14/491,234

(22) Filed: Sep. 19, 2014

(51) Int. Cl. H04R 31/00; H04R 7/02

(52) U.S. Cl. CPC H04R 31/00; H04R 7/02

(57) ABSTRACT

The present disclosure illustrates a diaphragm and manufacturing method thereof. The diaphragm includes a ring-like diaphragm edge made of metal material and a diaphragm film formed by graphene film plate. The diaphragm film is fixedly connected with an edge of the diaphragm. The present disclosure uses the metal ring and the graphene film to form the diaphragm, to increase sensitivity and strength of the diaphragm. At the same time, the diaphragm of the present disclosure can meet the requirement for minimized manufacturing by utilizing manufacturing processes of CVD, PVD, exposure, and development.

### BACKGROUND OF THE INVENTION

1. Field of the Invention

The present disclosure relates to a speaker field, and more particularly to a diaphragm and manufacturing method thereof.

2. Description of the Related Art

A diaphragm, also called a vibrated film, is vibrating during its working period and having a physical characteristic: thin. The diaphragm can be used to produce a vibration system and widely applied to microphones and speakers. With the development of minimized electronic device, the design of the diaphragm towards the miniaturization trend. The current method of manufacturing diaphragm can generate a diaphragm with satisfied parameters, but the parameters of the sensitivity, the strength, and the weight still need to be improved and enhanced.

### SUMMARY OF THE INVENTION

The objective of the present disclosure directs to a diaphragm capable of realizing minimized manufacture and having high sensitivity, and a method of manufacturing the diaphragm.

To achieve above objective, the present disclosure provides a method of manufacturing diaphragm including following steps:

(1) attaching at least two diaphragm rings on a graphene film and covering the plate graphene film on one side of each of the diaphragm rings; and

(2) trimming the graphene film along an outer edge of the diaphragm rings, to obtain at least two diaphragms, each of the diaphragms has a diaphragm edge formed by the diaphragm ring, and a diaphragm film formed by the trimmed graphene film.

Preferably, the graphene film in the step (1) is die cut according to the shape of the diaphragm ring and divide into at least two graphene film units partially connected with each other, and the diaphragm ring is fixedly attached on a corresponding graphene film unit by a carrier.

Preferably, the step (1) of the method of the present disclosure further includes a step: producing at least two base units made of cooper material and partially connected with each other according to the shape of the diaphragm ring; growing at least two graphene film units partially connected with each other on the surfaces of the base units by utilizing chemical vapor deposition; transferring the grown graphene film units partially connected with each other, and fixedly attaching the diaphragm ring on the corresponding graphene film unit by a carrier.

Preferably, the superimposing combination of the graphene film and a vacuum coating can be performed by utilizing PVD (physical vapor deposition) or CVD (chemical vapor deposition) for multiple times.

Preferably, the diaphragm ring and the graphene film are connected by utilizing chemical vapor deposition or adhered by utilizing glue.

Preferably, the diaphragm ring in the step (1) is a copper ring. Because of the self-healing ability of the graphene, when the diaphragm ring includes the copper ring or others metal that can be applied to grow graphene, the graphene is grown on surfaces of the copper rings by utilizing the chemical vapor deposition (CVD). Then, the graphene film units are connected with each other by utilizing the self-healing ability of the graphene (Carbon atoms has a binding tendency).

Preferably, the step (1) further comprises following steps:

a) attaching the graphene film on a surface of a copper base plate by utilizing chemical vapor deposition;

b) attaching a photographic film on another surface of the copper base plate, and producing a film slice according to the shape of the diaphragm and required width of the diaphragm ring, and then attaching the film slice on the photographic film and exposing the photographic film;

c) removing the film slice and washing an unexposed part of the photographic film and corroding an unnecessary part of the copper base plate by immersing the copper base plate into an etchant solution; and

d) obtaining a copper ring attached on the graphene film by removing the remained photographic film.

Compared with the prior arts, the present disclosure with above technical features has following advantages.

The diaphragm of the present disclosure is formed by using the metal ring and the graphene film, so the sensitivity and strength of the diaphragm can be improved. At the same time, the diaphragm of the present disclosure can meet the requirement for minimized manufacturing by utilizing manufacturing processes of exposure and development.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of a graphene film according to the embodiment of the present disclosure.

FIG. 2 is a schematic view of an un-trimmed diaphragm according to the embodiment of the present disclosure.

FIG. 3 is a schematic view of a manufactured diaphragm of the present disclosure.

FIG. 4 is a schematic view of an un-trimmed diaphragm according to the second embodiment of the present disclosure.

FIG. 5 is a schematic view of a film slice according to a third embodiment of the present disclosure.

FIG. 6 is a schematic view of an etched graphene film and an etched copper ring according to the third embodiment of the present disclosure.

### DETAILED DESCRIPTION OF THE PREFERRED EMBODIMENTS

Reference will now be made in detail to the exemplary embodiments of the present disclosure, examples of which are illustrated in the accompanying drawings.

### The First Embodiment

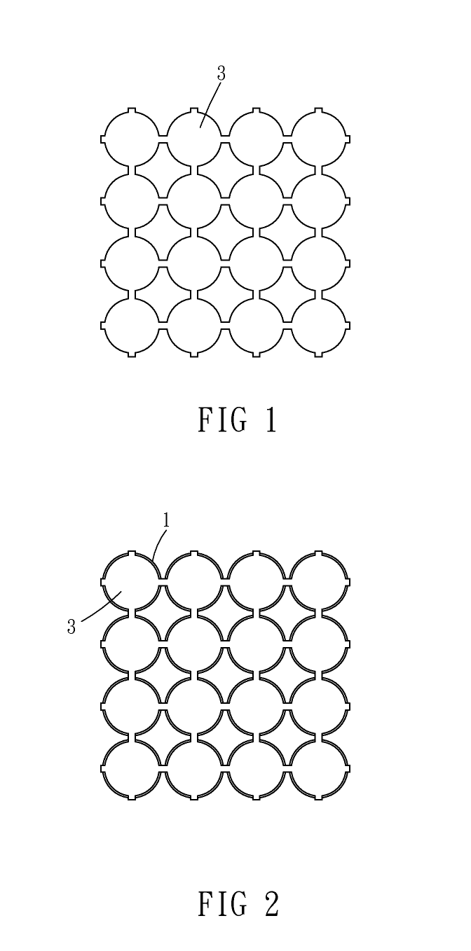

Please refer to FIG. 1 through FIG. 3. A method of manufacturing diaphragm has following steps:

In step (a), the graphene film is die cut according to the shape of the diaphragm ring 1 and divide into at least two graphene film units 3 partially connected each other (as shown in FIG. 1).

In step (b), the diaphragm ring 1 is fixedly attached on the corresponding graphene film unit 3 by a carrier (as shown in FIG. 2).

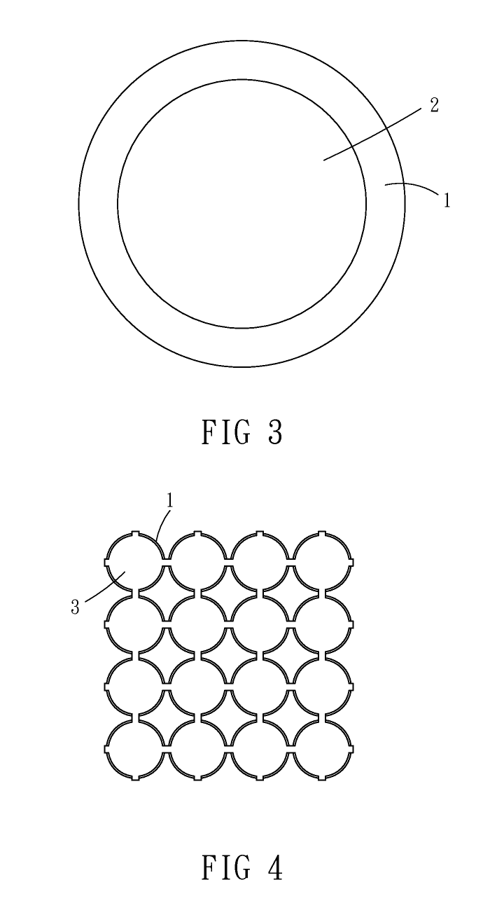

In step (c), the graphene film is trimmed along an outer edge of the diaphragm rings 1 so as to obtain at least two diaphragms, each of the diaphragms has a diaphragm edge formed by the diaphragm ring 1 and a diaphragm film 2 formed by the trimmed graphene film (as shown in FIG. 3).

### The Second Embodiment

Please refer to FIG. 3 and FIG. 4. The features of the second embodiment are similar to that of the first embodiment but the difference is presented as below. First, the second embodiment produces at least two base units made of cooper material and partially connected with each other according to the shape of the diaphragm ring 1, generates at least two graphene film units 3 partially connected with each other on the surfaces of the base units by utilizing chemical vapor deposition, and then transfers the grown graphene film units 3 partially connected with each other, and fixedly attaches the diaphragm ring 1 on the corresponding graphene film unit 3 by a carrier.

In the first embodiment and the second embodiment, the material of the diaphragm ring 1 includes a common material that is applied to produce a diaphragm edge. The diaphragm ring 1 and the graphene film unit 3 are fixedly adhered by utilizing the chemical vapor deposition or glue (conductive glue, silver glue, UV glue, and etc.).

### The Third Embodiment

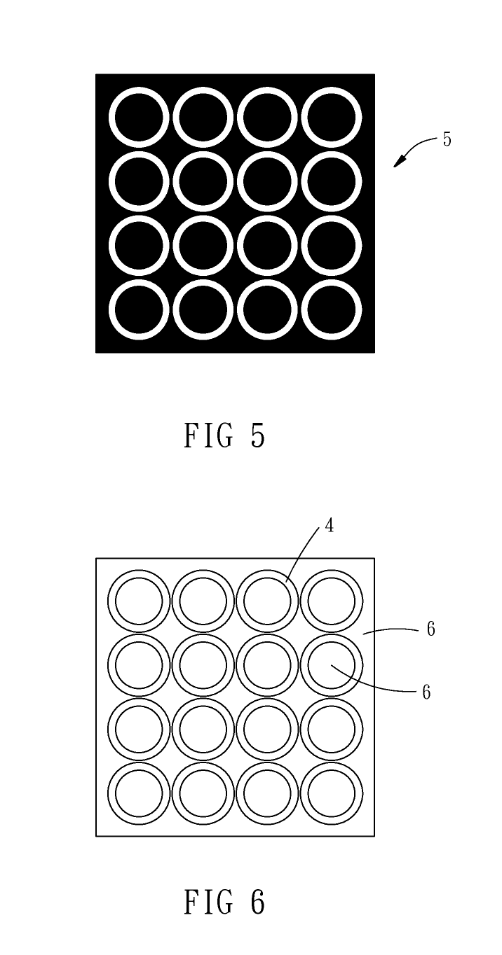

Please refer to FIG. 5 and FIG. 6. A method of manufacturing diaphragm has following steps:

In step (a), the graphene film 6 is attached on a surface of a copper base plate by utilizing chemical vapor deposition;

In step (b), a photographic film is attached on other surface of the copper base plate, and a film slice 5 is produced according to the shape of the diaphragm and required width of the diaphragm ring 1, and the film slice 5 having multiple patterns of copper rings is attached on the photographic film and then the photographic film is exposed.

In step (c) the film slice 5 is removed and an unexposed part of the photographic film is washed, and the copper base plate is immersed into an etchant to corrode an unnecessary part of the copper base plate.

In step (d), a copper ring 4 attached on the graphene film 6 is obtained by removing the remained photographic film.

In step (e), the part of graphene film 6 outside the copper ring 4 is trimmed along an outer edge of the copper ring 4, to obtain at least two diaphragms (as shown in FIG. 3), and each of the diaphragms has a diaphragm edge formed by the diaphragm ring 1 and a diaphragm film 2 formed by trimming the graphene film 6.

The diaphragm of the embodiment has the features of high sensitivity and high strength. At the same time, the diaphragm of the present disclosure can meet the requirement for minimized manufacturing by utilizing manufacturing processes of CVD, PVD, exposure, and development.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of manufacturing diaphragm, comprising following steps:
(1) attaching at least two diaphragm rings on a graphene film and covering the plate graphene film on one side of each of the diaphragm rings; and
(2) trimming the graphene film along an outer edge of the diaphragm rings, to obtain at least two diaphragms, wherein each of the diaphragms has a diaphragm edge formed by the diaphragm ring, and a diaphragm film formed by the trimmed graphene film.

2. The method of claim 1, wherein the graphene film in the step (1) is die cut according to the shape of the diaphragm ring and divide into at least two graphene film units partially connected with each other and the diaphragm ring is fixedly attached on a corresponding graphene film unit by a carrier.

3. The method of claim 1, the step (1) further comprising producing at least two base units made of cooper material and partially connected with each other according to the shape of the diaphragm ring; generating at least two graphene film units partially connected with each other on the surfaces of the base units by utilizing chemical vapor deposition; and transferring the grown graphene film units partially connected with each other, and fixedly attaching the diaphragm ring on the corresponding graphene film unit by a carrier.

4. The method of claim 1, wherein the superimposing combination of the graphene film and a vacuum coating is performed by utilizing physical vapor deposition or chemical vapor deposition for multiple times.

5. The method of claim 1, wherein the diaphragm ring and the graphene film are connected by utilizing chemical vapor deposition or adhered by utilizing glue.

6. The method of claim 1, wherein the diaphragm ring in the step (1) is a copper ring.

7. The method of claim 6, wherein the step (1) further comprises following steps:
a) attaching the graphene film on a surface of a copper base plate by utilizing chemical vapor deposition;
b) attaching a photographic film on other surface of the copper base plate, producing a film slice according to the shape of the diaphragm and required width of the diaphragm ring, and attaching the film slice on the photographic film and exposing the photographic film;
c) removing the film slice and washing an unexposed part of the photographic film, and corroding an unnecessary part of the copper base plate by immersing the copper base plate into an etchant; and
d) obtaining a copper ring attached on the graphene film by removing the remained photographic film.
